(19) United States
(12) Patent Application Publication
(10) Pub. No.: US 2014/0356776 A1
(43) Pub. Date: Dec. 4, 2014

(54) CORE/SHELL CHARGE CONTROL LATEX FOR EA PARTICLES

(71) Applicant: XEROX CORPORATION, Norwalk, CT (US)

(72) Inventors: ROBERT D. BAYLEY, FAIRPORT, NY (US); MAURA A. SWEENEY, IRONDEQUOIT, NY (US); GRAZYNA E. KMIECIK-LAWRYNOWICZ, FAIRPORT, NY (US); SHIGANG STEVEN QIU, NORWALK, CT (US); TIE HWEE NG, NORWALK, CT (US)

(21) Appl. No.: 13/907,800

(22) Filed: May 31, 2013

(51) Int. Cl. G03G 9/093

(52) U.S. Cl. CPC G03G 9/09335; G03G 9/09321
USPC 430/108.3; 430/108.4; 430/108.6; 430/108.7; 430/110.2

(57) ABSTRACT

A toner particle includes a core including at least one resin, optionally a wax, and a colorant, and a shell comprising at least one charge control agent. The core is substantially free of the charge control agent. The toner particle has improved charging performance compared with core-shell toner particles having the charge control agent in the core of the toner particle.

### TECHNICAL FIELD

This disclosure is generally directed to toner particles, and methods for producing such toner particles, for use in toners for forming and developing images of good quality. More specifically, this disclosure is directed to toner particles having a core-shell structure, and methods for producing such toner particles.

### BACKGROUND

Numerous processes are known for the preparation of toner particles, such as, for example, processes wherein a resin is melt kneaded or extruded with a pigment, micronized, and pulverized. Toner particles may also be produced by emulsion aggregation (EA) methods. Methods of preparing an EA type toner particles are within the purview of those skilled in the art, and such toner particles may be formed by aggregating a colorant with a latex polymer formed by emulsion polymerization. Combinations of amorphous and crystalline polyesters may be used in the EA process. This resin combination may provide toner particles with high gloss and relatively low-melting point characteristics, which allows for more energy efficient and faster printing. Unfortunately, the crystalline polyester may migrate to the surface of the toner particle which, in turn, may adversely decrease the charging characteristics of the toner, particularly in higher temperature and/or higher humidity conditions.

Various processes/modifications have been suggested to avoid these issues. For example, the application of shells to the toner particles may be one way to minimize the migration of a crystalline polyester to the toner particle surface. In other cases, charge control agents (CCAs) may be added to the bulk of the toner particle during the melt mixing process to improve the charging performance. However, addition of a charge control agent (CCA) to the bulk of the toner particle is often unsuccessful because the CCA often increases toner charging only in C-zone conditions and not in A-zone conditions, leading to higher sensitivity.

There remains a need for a toner particle suitable for use in toners for high speed printing having improved charging performance.

### SUMMARY

The following detailed description is of the best currently contemplated modes of carrying out exemplary embodiments of the present disclosure. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present disclosure generally provide a toner particle including a core and a polymeric shell encapsulating the core and having at least one charge control agent intercalated within, wherein the core is substantially free of the charge control agent.

In another aspect of the present disclosure, a toner composition includes a toner particle having a core with at least a resin, optionally a wax, and one or more pigments, the core being substantially free of a charge control agent, a polymeric shell encapsulating the core and having at least one charge control agent intercalated within, and one or more flow aid additives.

In yet another aspect of the present disclosure a method for making a toner particle includes the steps of forming a particle core, encapsulating the particle core with a shell comprising a charge control agent, and keeping the particle core substantially free of the charge control agent.

### DETAILED DESCRIPTION

The embodiments herein provide toner particles suitable in toners for high speed printing having improved charging performance. The toner particles of the embodiments herein have a core-shell structure with a charge control agent (CCA) in the shell, but substantially not in the core. The toner particle according to the present disclosure has improved charging performance compared to a core-shell toner particle having a CCA added to the core of the toner particle.

In embodiments, the toner particle may be prepared by emulsion-aggregation processes, such as a process that includes aggregating a mixture of an optional colorant, an optional wax and any other desired or required additives, and emulsions resins, optionally in surfactants, and then coalescing the aggregate mixture. A mixture may be prepared by adding a colorant and optionally a wax or other materials, which may also be optionally in a dispersion including a surfactant, to the emulsion, which may be a mixture of two or more emulsions containing the resin. The pH of the resulting mixture may be adjusted by an acid. Additionally, in embodiments, the mixture may be homogenized. Then, a shell can be applied to encapsulate the aggregated particles.

Although embodiments relating to toner particle production are described below with respect to emulsion-aggregation processes, any suitable method of preparing toner particles may be used, including chemical processes, such as suspension.

### Core of the Toner Particle

Any latex resin may be utilized in forming a toner core of the embodiments herein. Such resins, in turn, may be made of any suitable monomer. Any monomer employed may be selected depending upon the particular polymer to be utilized.

The monomer may be produced by conventional methods. Suitable monomers useful in forming a latex emulsion, and thus the resulting latex particles in the latex emulsion, include, but are not limited to, styrene; p-chlorostyrene unsaturated mono-olefins such as ethylene, propylene, butylene, isobutylene, and the like; saturated mono-olefins such as vinyl acetate, vinyl propionate, and vinyl butyrate; vinyl esters such as esters of monocarboxylic acids including methyl acrylate, ethyl acrylate, n-butylacrylate, isobutyl acrylate, dodecyl acrylate, n-octyl acrylate, phenyl acrylate, methyl methacrylate, ethyl methacrylate, and butyl methacrylate; acrylonitrile; methacrylonitrile; acrylamide; mixtures thereof; and the like. In addition, cross-linked resins, including polymers, copolymers, and homopolymers of styrene polymers, may be selected. The latex resin may also be made of an amorphous resin, a crystalline resin, and/or a combination thereof. In further embodiments, the polymer utilized to form the resin core may be a polyester resin, mixture of an amorphous polyester resin, and a crystalline polyester resin.

Exemplary polymers include styrene acrylates, styrene butadienes, styrene methacrylates, and more specifically, poly(styrene-alkyl acrylate), poly(styrene-1,3-diene), poly(styrene-alkyl methacrylate), poly(styrene-alkyl acrylate-acrylic acid), poly(styrene-1,3-diene-acrylic acid), poly(styrene-alkyl methacrylate-acrylic acid), poly(alkyl methacrylate-alkyl acrylate), poly(alkyl methacrylate-aryl acrylate), poly(aryl methacrylate-alkyl acrylate), poly(alkyl methacrylate-acrylic acid), poly(styrene-alkyl acrylate-acrylonitrile-acrylic acid), poly(styrene-1,3-diene-acrylonitrile-acrylic acid), poly(alkyl acrylate-acrylonitrile-acrylic acid), poly(styrene-butadiene), poly(methylstyrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene), poly(styrene-propyl acrylate), poly(styrene-butyl acrylate), poly(styrene-butadiene-acrylic acid), poly(styrene-butadiene-methacrylic acid), poly(styrene-butadiene-acrylonitrile-acrylic acid), poly(styrene-butyl acrylate-acrylic acid), poly(styrene-butyl acrylate-methacrylic acid), poly(styrene-butyl acrylate-acrylononitrile), poly(styrene-butyl acrylate-acrylonitrile-acrylic acid), poly(styrene-butadiene), poly(styrene-isoprene), poly(styrene-butyl methacrylate), poly(styrene-butyl acrylate-acrylic acid), poly(styrene-butyl methacrylate-acrylic acid), poly(butyl methacrylate-butyl acrylate), poly(butyl methacrylate-acrylic acid), poly(acrylonitrile-butyl acrylate-acrylic acid), and combinations thereof. The polymer may be block, random, or alternating copolymers. In embodiments, a poly(styrene-butyl acrylate) may be utilized as the latex. The glass transition temperature of the poly(styrene-butyl acrylate) may be from about 35° C. to about 75° C., and in other embodiments from about 40° C. to about 70° C., or from about 45° C. to about 55° C.

An example of a linear propoxylated bisphenol A fumarate resin which may be utilized as a latex resin is available under the trade name SPARII from Resana S/A Industrias Quimicas, Sao Paulo Brazil. Other propoxylated bisphenol A fumarate resins that may be utilized and are commercially available include GTUF and FPESL-2 from Kao Corporation, Japan, and EM181635 from Reichhold, Research Triangle Park, N.C., and the like.

Suitable crystalline resins which may be utilized, optionally in combination with an amorphous resin, may include a resin formed of ethylene glycol and a mixture of dodecanedioic acid and fumaric acid co-monomers:

In embodiments, the latex resin may be a cross-linkable resin. A cross-linkable resin is a resin including a cross-linkable group or groups such as a C═C bond. The resin can be cross-linked, for example, through a free radical polymerization with an initiator. Thus, in embodiments, a resin utilized for forming the core may be partially cross-linked, which may be referred to, in embodiments, as a “partially cross-linked polyester resin” or a “polyester gel”. In embodiments, from about 1% by weight to about 50% by weight of the polyester gel may be cross-linked, and in other embodiments from about 5% by weight to about 35% by weight of the polyester gel may be cross-linked.

### Initiators

In various embodiments, initiators may be added for formation of the latex. Examples of suitable initiators include water soluble initiators, such as ammonium persulfate, sodium persulfate and potassium persulfate, and organic soluble initiators including organic peroxides and azo compounds including Vazo peroxides, such as VAZO 64™ 2-methyl 2-2′-azobis propanenitrile, VAZO 88™, 2-2′-azobis isobutyramide dehydrate, and combinations thereof. Other water-soluble initiators which may be utilized include azoamidine compounds, for example 2,2′-azobis(2-methyl-N-phenylpropionamidine)dihydrochloride, 2,2′-azobis[N-(4-chlorophenyl)-2-methylpropionamidine]di-hydrochloride, 2,2′-azobis[N-(4-hydroxyphenyl)-2-methyl-propionamidine]dihydrochloride, 2,2′-azobis[N-(4-amino-phenyl)-2-methylpropionamidine]tetrahydrochloride, 2,2′-azobis[2-methyl-N(phenylmethyl)propionamidine]dihydrochloride, 2,2′-azobis[2-methyl-N-2-propenylpropionamidine]dihydrochloride, 2,2′-azobis[N-(2-hydroxy-ethyl)2-methylpropionamidine]dihydrochloride, 2,2′-azobis[2(5-methyl-2-imidazolin-2-yl)propane]dihydrochloride, 2,2′-azobis[2-(2-imidazolin-2-yl)propane]dihydrochloride, 2,2′-azobis[2-(4,5,6,7-tetrahydro-1H-1,3-diazepin-2-yl)propane]dihydrochloride, 2,2′-azobis[2-(3,4,5,6-tetrahydropyrimidin-2-yl)propane]dihydrochloride, 2,2′-azobis[2-(5-hydroxy-3,4,5,6-tetrahydropyrimidin-2-yl)propane]dihydrochloride, 2,2′-azobis 12-[1-(2-hydroxyethyl)-2-imidazolin-2-yl]propane}dihydrochloride, combinations thereof, and the like.

Initiators can be added in suitable amounts, such as from about 0.1 to about 8 weight percent, and in some embodiments of from about 0.2 to about 5 weight percent of the monomers. In other embodiments, initiators may be present from about 0.3 to about 4.5, or from about 0.4 to about 4.0, or from about 0.9 to about 3.5 weight percent of the monomers.

In embodiments, the latex resin may be formed by emulsion polymerization methods.

In embodiments, colorants, waxes, and other additives utilized to form the core of the toner particle may be in dispersions including surfactants. Moreover, toner particles may be formed by emulsion aggregation methods where the resin and other components of the toner are placed in one or more surfactants; an emulsion is formed; and toner particles are aggregated, coalesced, optionally washed and dried, and recovered.

### Surfactants

In some embodiments, the latex resin may be prepared in an aqueous phase containing a surfactant or co-surfactant. Surfactants which may be utilized with the resin to form a latex dispersion can be ionic or nonionic surfactants in an amount of from about 0.01 to about 15 weight percent of the solids, and in other embodiments of from about 0.1 to about 10 weight percent of the solids.

Anionic surfactants which may be utilized include sulfates and sulfonates, sodium dodecylsulfate (SDS), sodium dodecylbenzene sulfonate, sodium dodecylnaphthalene sulfate, dialkyl benzenealkyl sulfates and sulfonates, acids such as abietic acid available from Aldrich, NEOGEN R™, NEOGEN SC™ obtained from Daiichi Kogyo Seiyaku Co., Ltd., combinations thereof, and the like. Other suitable anionic surfactants include, in embodiments, DOWFAX™ 2A1, an alkyldiphenyloxide disulfonate from The Dow Chemical Company, and/or TAYCA POWER BN2060 from Tayca Corporation (Japan), which are branched sodium dodecyl benzene sulfonates. Combinations of these surfactants and any of the foregoing anionic surfactants may be utilized in embodiments.

Examples of cationic surfactants include, but are not limited to, ammoniums, for example, alkylbenzyl dimethyl ammonium chloride, dialkyl benzenealkyl ammonium chloride, lauryl trimethyl ammonium chloride, alkylbenzyl methyl ammonium chloride, alkyl benzyl dimethyl ammonium bromide, benzalkonium chloride, C12, C15, C17 trimethyl ammonium bromides, combinations thereof, and the like. Other cationic surfactants include cetyl pyridinium bromide, halide salts of quaternized polyoxyethylalkylamines, dodecylbenzyl triethyl ammonium chloride, MIRAPOL and ALKAQUAT available from Alkaril Chemical Company, SANISOL (benzalkonium chloride), available from Kao Chemicals, combinations thereof, and the like. In embodiments a suitable cationic surfactant includes SANISOL B-50 available from Kao Corp., which is primarily a benzyl dimethyl alkonium chloride.

Examples of nonionic surfactants include, but are not limited to, alcohols, acids and ethers, for example, polyvinyl alcohol, polyacrylic acid, methalose, methyl cellulose, ethyl cellulose, propyl cellulose, hydroxyl ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy) ethanol, combinations thereof, and the like. In embodiments commercially available surfactants from Rhone-Poulenc such as IGEPAL CA-210™, IGEPAL CA-520™, IGEPAL CA-720™, IGEPAL CO-890™, IGEPAL CO720™, IGEPAL CO290™, IGEPAL CA-210™, ANTAROX 890™ and ANTAROX 897™ can be utilized. The choice of particular surfactants or combinations thereof, as well as the amounts of each to be used, is within the purview of those skilled in the art.

### Colorants

The colorants may include dyes, pigments, mixtures of dyes, mixtures of pigments, mixtures of dyes and pigments, and the like, may be included in the toner. The colorant may be included in the core of the toner particle in an amount of, for example, about 0.1 to about 35 percent by weight of the toner, or from about 1 to about 15 weight percent of the toner, or from about 3 to about 10 percent by weight of the toner.

As examples of suitable colorants, mention may be made of carbon black like REGAL 330®; magnetites, such as Mobay magnetites MO8029™, MO8060™; Columbian magnetites; MAPICO BLACKS™ and surface treated magnetites; Pfizer magnetites CB4799™, CB5300™, CB5600™, MCX6369™; Bayer magnetites, BAYFERROX 8600™, 8610™; Northern Pigments magnetites, NP-604™, NP-608™; Magnox magnetites TMB-100™, or TMB-104™; and the like. As colored pigments, there can be selected cyan, magenta, yellow, red, green, brown, blue or mixtures thereof. Generally, cyan, magenta, or yellow pigments or dyes, or mixtures thereof, are used. The pigment or pigments are generally used as water based pigment dispersions.

Specific examples of pigments include SUNSPERSE 6000, FLEXIVERSE and AQUATONE water based pigment dispersions from SUN Chemicals, HELIOGEN BLUE L6900™, D6840™, D7080™, D7020™, PYLAM OIL BLUET™, PYLAM OIL YELLOW™, PIGMENT BLUE 1™ available from Paul Uhlich & Company, Inc., PIGMENT VIOLET 1™, PIGMENT RED 48™, LEMON CHROME YELLOW DCC 1026™, E.D. TOLUIDINE RED™ and BON RED C™ available from Dominion Color Corporation, Ltd., Toronto, Ontario, NOVAPERM YELLOW FGL™, HOSTAPERM PINK ET from Hoechst, and CINQUASIA MAGENTA™ available from E.I. DuPont de Nemours & Company, and the like. Generally, colorants that can be selected are black, cyan, magenta, or yellow, and mixtures thereof. Examples of magentas are 2,9-dimethyl-substituted quinacridone and anthraquinone dye identified in the Color Index as CI 60710, CI Dispersed Red 15, diazo dye identified in the Color Index as CI 26050, CI Solvent Red 19, and the like. Illustrative examples of cyans include copper tetra(octadecyl sulfonamido) phthalocyanine, x-copper phthalocyanine pigment listed in the Color Index as CI 74160, CI Pigment Blue, Pigment Blue 15:3, and Anthrathrene Blue, identified in the Color Index as CI 69810, Special Blue X-2137, and the like. Illustrative examples of yellows are diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33 2,5-dimethoxy-4-sulfonanilide phenylazo-4′-chloro-2,5-dimethoxy acetoacetanilide, and Permanent Yellow FGL. Colored magnetites, such as mixtures of MAPICO BLACK™, and cyan components may also be selected as colorants. Other known colorants can be selected, such as Levanyl Black A-SF (Miles, Bayer) and Sunsperse Carbon Black LHD 9303 (Sun Chemicals), and colored dyes such as Neopen Blue (BASF), Sudan Blue OS (BASF), PV Fast Blue B2G01 (American Hoechst), Sunsperse Blue BHD 6000 (Sun Chemicals), Irgalite Blue BCA (Ciba-Geigy), Paliogen Blue 6470 (BASF), Sudan III (Matheson, Coleman, Bell), Sudan II (Matheson, Coleman, Bell), Sudan IV (Matheson, Coleman, Bell), Sudan Orange G (Aldrich), Sudan Orange 220 (BASF), Paliogen Orange 3040 (BASF), Ortho Orange OR 2673 (Paul Uhlich), Paliogen Yellow 152, 1560 (BASF), Lithol Fast Yellow 0991K (BASF), Paliotol Yellow 1840 (BASF), Neopen Yellow (BASF), Novoperm Yellow FG 1 (Hoechst), Permanent Yellow YE 0305 (Paul Uhlich), Lumogen Yellow D0790 (BASF), Sunsperse Yellow YHD 6001 (Sun Chemicals), Suco-Gelb L1250 (BASF), Suco-Yellow D1355 (BASF), Hostaperm Pink E (American Hoechst), Fanal Pink D4830 (BASF), Cinquasia Magenta (DuPont), Lithol Scarlet D3700 (BASF), Toluidine Red (Aldrich), Scarlet for Thermoplast NSD PS PA (Ugine Kuhlmann of Canada), E.D. Toluidine Red (Aldrich), Lithol Rubine Toner (Paul Uhlich), Lithol Scarlet 4440 (BASF), Bon Red C (Dominion Color Company), Royal Brilliant Red RD-8192 (Paul Uhlich), Oracet Pink RF (Ciba-Geigy), Paliogen Red 3871K (BASF), Paliogen Red 3340 (BASF), Lithol Fast Scarlet L4300 (BASF), combinations of the foregoing, and the like.

### Wax

Wax dispersions may also be added during formation of a latex or toner particle in an emulsion aggregation synthesis. Suitable waxes include, for example, submicron wax particles in the size range of from about 50 to about 1000 nanometers, and in some embodiments of from about 100 to about 500 nanometers in volume average diameter, suspended in an aqueous phase of water and an ionic surfactant, nonionic surfactant, or combinations thereof. Suitable surfactants include those described above. The ionic surfactant or nonionic surfactant may be present in an amount of from about 0.1 to about 20 percent by weight, and in other embodiments of from about 0.5 to about 15 percent by weight of the wax.

The wax dispersion according to embodiments of the present disclosure may include, for example, a natural vegetable wax, natural animal wax, mineral wax, and/or synthetic wax. Examples of natural vegetable waxes include, for example, carnauba wax, candelilla wax, Japan wax, and bayberry wax. Examples of natural animal waxes include, for example, beeswax, punic wax, lanolin, lac wax, shellac wax, and spermaceti wax. Mineral waxes include, for example, paraffin wax, microcrystalline wax, montan wax, ozokerite wax, ceresin wax, petrolatum wax, and petroleum wax. Synthetic waxes of the present disclosure include, for example, Fischer-Tropsch wax, acrylate wax, fatty acid amide wax, silicone wax, polytetrafluoroethylene wax, polyethylene wax, polypropylene wax, and combinations thereof.

Examples of polypropylene and polyethylene waxes may include those commercially available from Allied Chemical and Baker Petrolite; wax emulsions available from Michelman Inc. and the Daniels Products Company; EPOLENE N-15 commercially available from Eastman Chemical Products, Inc.; VISCOL 550-P, a low weight average molecular weight polypropylene available from Sanyo Kasel K. K., and similar materials. In embodiments, commercially available polyethylene waxes possess a molecular weight (Mw) of from about 100 to about 5000, and in other embodiments of from about 250 to about 2500, while the commercially available polypropylene waxes have a molecular weight of from about 200 to about 10,000, and in some embodiments of from about 400 to about 5000.

In embodiments, the waxes may be functionalized. Examples of groups added to functionalize waxes include amines, amides, imides, esters, quaternary amines, and/or carboxylic acids. In some embodiments, the functionalized waxes may be acrylic polymer emulsions, for example, JONCRYL 74, 89, 130, 537, and 538, all available from Johnson Diversey, Inc.; or chlorinated polypropylenes and polyethylenes commercially available from Allied Chemical, Baker Petrolite Corporation and Johnson Diversey, Inc. The wax may be present in an amount of from about 0.1 to about 30 percent by weight, and in some embodiments from about 2 to about 20 percent by weight of the toner.

### Additives

In embodiments, the toner particles may also contain other optional additives, as desired or required. For example, there can be blended with the toner particles external additive particles including flow aid additives, which additives may be present on the surface of the toner particles. Examples of these additives include metal oxides such as titanium oxide, silicon oxide, tin oxide, mixtures thereof, and the like; colloidal and amorphous silicas, such as AEROSIL®, metal salts and metal salts of fatty acids inclusive of zinc stearate, aluminum oxides, cerium oxides, and mixtures thereof. Each of these external additives may be present in an amount of from about 0.1 percent by weight to about 5 percent by weight of the toner particle, and in other embodiments of from about 0.25 percent by weight to about 3 percent by weight of the toner particle.

Toners produced in accordance with the present disclosure may possess excellent charging characteristics when exposed to extreme relative humidity conditions.

### Aggregating Agents

In embodiments, the toner particles may include an aggregating agent. Any suitable aggregating agent may be utilized to form the toner particle. Suitable aggregating agents include, for example, aqueous solutions of a divalent cation or a multivalent cation material. The aggregating agent may be, for example, polyaluminum halides such as polyaluminum chloride (PAC), or the corresponding bromide, fluoride, or iodide, polyaluminum silicates such as polyaluminum sulfosilicate (PASS), and water soluble metal salts including aluminum chloride, aluminum nitrite, aluminum sulfate, potassium aluminum sulfate, calcium acetate, calcium chloride, calcium nitrite, calcium oxylate, calcium sulfate, magnesium acetate, magnesium nitrate, magnesium sulfate, zinc acetate, zinc nitrate, zinc sulfate, zinc chloride, zinc bromide, magnesium bromide, copper chloride, copper sulfate, and combinations thereof. In embodiments, the aggregating agent may be added to the mixture at a temperature that is below the glass transition temperature (Tg) of the resin.

The aggregating agent may be added to the mixture utilized to form a toner in an amount of, for example, from about 0.1% to about 8% by weight, in some embodiments from about 0.2% to about 5% by weight, and in other embodiments from about 0.5% to about 5% by weight, of the resin in the mixture. This provides a sufficient amount of agent for aggregation.

In order to control aggregation and subsequent coalescence of the particles, in embodiments the aggregating agent may be metered into the mixture over time. For example, the agent may be metered into the mixture over a period of from about 5 to about 240 minutes, and in other embodiments from about 30 to about 200 minutes. The addition of the agent may also be done while the mixture is maintained under stirred conditions, in embodiments from about 50 rpm to about 1,000 rpm, and in other embodiments from about 100 rpm to about 500 rpm, and at a temperature that is below the glass transition temperature of the resin as discussed above, in embodiments from about 30° C. to about 90° C., and in other embodiments from about 35° C. to about 70° C.

The particles may be permitted to aggregate until a predetermined desired particle size is obtained. A predetermined desired size refers to the desired particle size to be obtained as determined prior to formation, and the particle size being monitored during the growth process until such particle size is reached. Samples may be taken during the growth process and analyzed, for example with a Coulter Counter, for average particle size. The aggregation thus may proceed by maintaining the elevated temperature, or slowly raising the temperature to, for example, from about 30° C. to about 99° C., and holding the mixture at this temperature for a time from about 0.5 hours to about 10 hours, in other embodiments from about 1 hour to about 5 hours, while maintaining stirring, to provide the aggregated particles. Once the predetermined desired particle size is reached, then the growth process is halted. In embodiments, the predetermined desired particle size is within the toner particle size ranges mentioned above.

The growth and shaping of the particles following addition of the aggregation agent may be accomplished under any suitable conditions. For example, the growth and shaping may be conducted under conditions in which aggregation occurs separate from coalescence. For separate aggregation and coalescence stages, the aggregation process may be conducted under shearing conditions at an elevated temperature, for example of from about 40° C. to about 90° C., and other in embodiments from about 45° C. to about 80° C., which may be below the glass transition temperature of the resin as discussed above.

Once the desired final size of the toner particles is achieved, the pH of the mixture may be adjusted with a base to a value of from about 3 to about 10, and in other embodiments from about 5 to about 9. The adjustment of the pH may be utilized to freeze, that is to stop, toner growth. The base utilized to stop toner growth may include any suitable base such as, for example, alkali metal hydroxides such as, for example, sodium hydroxide, potassium hydroxide, ammonium hydroxide, combinations thereof, and the like. In embodiments, ethylene diamine tetraacetic acid (EDTA) may be added to help adjust the pH to the desired values noted above.

### Shell of Toner Particle

In embodiments, after aggregation, but prior to coalescence, the aggregated particles may be encapsulated by a shell over the aggregated particles. In accordance with embodiments herein, a charge control agent (CCA) may be incorporated into the toner shell by adding the CCA to an emulsion including the resin utilized to form the shell. Addition of the CCA to the emulsion resin provides substantially uniform distribution of the CCA throughout the shell, while the CCA is substantially absent from the core, and thus more uniform toner charging can be achieved.

Any latex resin may be utilized in forming the shell of the particle of the present disclosure. Such resins, in turn, may be made of any suitable monomer. The monomer may be produced by conventional methods. In some embodiments the toner particle may be produced by emulsion aggregation EA. Suitable monomers useful in forming a latex emulsion, and thus the resulting latex particles in the latex emulsion, include, but are not limited to, styrene; p-chlorostyrene unsaturated mono-olefins such as ethylene, propylene, butylene, isobutylene, and the like; saturated mono-olefins such as vinyl acetate, vinyl propionate, and vinyl butyrate; vinyl esters such as esters of monocarboxylic acids including methyl acrylate, ethyl acrylate, n-butylacrylate, isobutyl acrylate, dodecyl acrylate, n-octyl acrylate, phenyl acrylate, methyl methacrylate, ethyl methacrylate, and butyl methacrylate; acrylonitrile; methacrylonitrile; acrylamide; mixtures thereof; and the like. In addition, cross-linked resins, including polymers, copolymers, and homopolymers of styrene polymers, may be selected. The resins may be an amorphous resin, a crystalline resin, and/or a combination thereof.

### Charge Control Agents

Any CCA may be utilized in the shell of the toner particle of the embodiments herein. Exemplary CCAs include, but are not limited to, quaternary ammonium compounds inclusive of alkyl pyridinium halides; bisulfates; alkyl pyridinium compounds; organic sulfate and sulfonate compositions; cetyl pyridinium tetrafluoroborates; distearyl dimethyl ammonium methyl sulfate; aluminum salts and zinc salts, combinations thereof, and the like.

In embodiments, a suitable CCA includes an aluminum complex of 3,5-di-tert-butylsalicylic acid in powder form, commercially available as BONTRON E-88™ (from Orient chemical). Other suitable CCAs include, for example, BONTRON E-84™ (commercially available from Orient chemical), which is a zinc complex of 3,5-di-tert-butylsalicylic acid in powder form (BONTRON E-84™ is similar to BONTRON E-88™, except zinc is the counter ion instead of aluminum).

The emulsion including the resin and CCA may be prepared utilizing any method within the purview of those skilled in the art. In embodiments, the CCA and resin may be combined utilizing a solvent flash method, a solvent less emulsification method, or a phase inversion method.

In further embodiments, the CCA and resin may be combined using a solvent emulsification method, wherein the CCA and resin are dissolved in an organic solvent, followed by introducing the solution of the resin and organic solvent in deionized water under homogenization.

Any method within the purview of those skilled in the art may be used to encapsulate the aggregated particles within the shell, for example, by coacervation, dipping, layering, or painting. The encapsulation of the aggregated particles may occur, for example, while heating to an elevated temperature in embodiments from about 80° C. to about 99° C., or from about 88° C. to about 98° C., or from about 90° C. to about 96° C. The formation of the shell may take place for a period of time from about 1 minute to about 5 hours, or from about 5 minutes to about 3 hours, or from about 15 minute to about 2.5 hours.

In embodiments, the charge control agent may be incorporated in the latex shell polymerization in an amount of from about 0.01 percent to about 10 percent by weight of the toner shell composition, or from about 0.1 percent to about 6 percent by weight of the toner shell composition; or further from about 0.4 percent to about 4.5 percent by weight of the toner shell composition.

The charge control resin including about 0.01 to 4.5% CCA may be in an amount of from about 25 percent to about 35 percent by weight of the toner particle composition, or from about 26 percent to about 34 percent by weight of the toner particle, or from about 28 percent to about 32 percent by weight of the toner particle composition.

In embodiments, the toner core may have a diameter from about 4.8 microns to about 6.9 microns, in other embodiments from about 5.2 microns to about 6.4 microns, and in further embodiments from about 5.6 microns to about 6.6 microns.

In embodiments, the toner shell may have a thickness from about 0.1 microns to about 1 microns, in other embodiments from about 0.2 microns to about 0.8 microns, and in further embodiments from about 0.25 microns to about 0.65 microns.

Incorporation of a CCA in substantially only the shell portion of the toner particle can therefore reduce, compared to toner particles having the CCA homogeneously distributed in the toner core, the amount of CCA required and in addition provides better charging results.

### Coalescence

After adding the shell to the aggregated particles, the particles are then grown and coalesced to the desired final diameter, for example from about 3.0 μm to about 12 μm, or from about 4 μm to about 9 μm, or from about 5 μm to about 8 μm, the coalescence being achieved by, for example, heating the mixture.

After coalescence is complete and the particle shape achieved, the slurry may be cooled to room temperature. A suitable cooling method may include introducing cold water to a jacket around the reactor. After cooling, the toner particles may be optionally washed with water, and then dried. Drying may be accomplished by any suitable method for drying including, for example, freeze-drying.

The toner particles thus obtained may be formulated into a toner composition. For example, the toner particles may be mixed with carrier particles to achieve a two-component toner composition. Examples of carrier particles may include granular zircon, granular silicon, glass, steel, nickel, ferrites, iron ferrites, silicon dioxide, or mixture thereof. The carrier particles may be mixed with the toner particles in various suitable combinations to achieve the toner composition with desired characteristics.

The toner particles may also be blended with external additive including flow aid additives. Examples of these additives include metal oxides such as titanium oxide, silicon oxide, tin oxide, mixtures thereof; colloidal and amorphous silicas, such as AEROSIL®, metal salts and metal salts of fatty acids inclusive of zinc stearate, aluminum oxides, cerium oxides, and mixtures thereof.

### EXAMPLES

The following Example illustrates one exemplary embodiment of the present disclosure. This Example is intended to be illustrative only to show one of several methods of preparing the toner particle and is not intended to limit the scope of the present disclosure. Also, parts and percentages are by weight unless otherwise indicated.

### Example 1

### Core/Shell Latex CCA (Shell with about 4% by Weight Charge Control)

### Preparation of Oil in Water Emulsion A.

In a suitable mixing vessel were added a monomer mixture of about 1567 parts by weight of styrene, obtained from Shell Corporation and about 375 parts by weight of n-butyl acrylate, obtained from Scientific Polymer Products, about 13 parts by weight of dodecanethiol chain transfer agent, and about 58 parts by weight of β-carboxyethyl acrylate (β-CEA), obtained from Bimax in an amount of about 3% by weight based on the total weight of styrene/n-butyl acrylate. To the monomer mixture was added about 921 parts of distilled water and about 36 parts by weight of DOWFAX™ 2A1, an alkyldiphenyloxide disulfonate from The Dow Chemical Company. The above mixture was then subjected to a series of on and off stirring at about 500 RPM to obtain a stable oil in water emulsion. The oil in water emulsion was then maintained at constant stirring.

### Preparation of Monomer Mixture B Containing a Dissolved Charge Control Agent.

In a suitable mixing vessel were added a monomer mixture of about 451 parts by weight of styrene, obtained from Shell Corporation; about 108 parts by weight of n-butyl acrylate, obtained from Scientific Polymer Products; about 8 parts by weight of dodecanethiol chain transfer agent; about 17 parts by weight of β-carboxyethyl acrylate (β-CEA), obtained from Bimax in an amount of about 3% by weight based on the total weight of styrene/n-butyl acrylate; and about 22 parts by weight of 3,5 Di-tert-butylsalicylic acid, zinc salt CCA, obtained from Orient Corporation of America, in an amount of about 4% by weight based upon the total weight of the styrene/n-butyl acrylate. Upon stirring the monomer mixture for about 20 minutes, the 3,5 Di-tert-butylsalicylic acid, zinc salt was fully solubilized and incorporated into the monomer mixture.

### Preparation of a Surfactant Solution

In a suitable mixing vessel were added about 288 parts by weight of distilled water and about 25 parts by weight of weight of DOWFAX™ 2A1, an alkyldiphenyloxide disulfonate from The Dow Chemical Company. The components were then stirred to complete solution.

A latex resin was prepared by emulsion polymerization of the above monomer mix as follows.

An 8 liter jacketed glass reactor was fitted with two stainless steel 45° pitch semi-axial flow impellers one inch apart, a thermal couple temperature probe, a water cooled condenser with nitrogen outlet, a nitrogen inlet, internal cooling capabilities, and a hot water circulating bath. After reaching a jacket temperature of about 83° C. and continuous nitrogen purge, the reactor was charged with about 1649 parts by weight of distilled water and about 5.3 parts by weight of DOWFAX™ 2A1, an alkyldiphenyloxide disulfonate from The Dow Chemical Company. The stirrer was set at about 200 revolutions per minute (rpm) and maintained at this speed for about 2 hours with the reactor contents kept at a temperature of about 75° C. with the internal cooling system.

About 60 parts by weight of the monomer mixture A prepared above was transferred into the reactor and stirred for about 20 minutes to allow the reactor contents to equilibrate at about 75° C. An initiator solution was prepared in a suitable vessel from about 29 parts by weight of ammonium persulfate, obtained from FMC, and about 265 parts by weight of distilled water, and then the solution was stirred until dissolved. The initiator solution was then transferred over a period of about 20 minutes to initiate polymerization and formation of seed particles which were about 47 nm volume average diameter as obtained on a Honeywell MICROTRAC® UPA 150 light scattering instrument.

After an additional 20 minutes, about 1476 parts of monomer mixture A was fed into the reactor containing the seed particles over a period of about 130 minutes with a resulting particle size of about 128 nm volume average diameter as obtained on a Honeywell MICROTRAC® UPA 150 light scattering instrument.

To the remaining Monomer mix A was added about 23 parts of distilled water and about 14 parts by weight of dodecanethiol chain transfer agent. The monomer feed was then continued, an dodecanethiol chain transfer agent was added, for a period of about 34 minutes, with a resulting particle size of about 147 nm volume average diameter as obtained on a Honeywell MICROTRAC® UPA 150 light scattering instrument.

At this time, monomer mixture B containing about 22 parts of dissolved charge control 3,5 Di-tert-butylsalicylic acid, zinc salt CCA, obtained from Orient Corporation of America, in an amount of about 4% by weight based upon the total weight of the styrene/n-butyl Acrylate, was added over a period of 83 minutes. Simultaneously started was the addition of the prepared surfactant solution of the of DOWFAX™ 2A1, an alkyldiphenyloxide disulfonate from The Dow Chemical Company in distilled water and delivered over a period of 20 minutes.

After the complete addition of monomer mixture B containing about 22 parts of dissolved charge control 3,5 Di-tert-butylsalicylic acid, zinc salt CCA, obtained from Orient Corporation of America, a resulting particle size of about 167 nm volume average diameter was obtained on a Honeywell MICROTRAC® UPA 150 light scattering instrument. The reactor contents were maintained at 75° C. with stirring to complete conversion of the residual monomers, resulting in a final particle size of about 169 nm volume average diameter as obtained on a Honeywell MICROTRAC® UPA 150 light scattering instrument.

The resulting latex resin, with a final average volume diameter of 169 nm, was comprised of about 70% by weight core, volume diameter of about 147 nm containing no 3,5 Di-tert-butylsalicylic acid, zinc salt charge control additive, and about 30% by weight shell comprised of about 4% by weight 3,5 Di-tert-butylsalicylic acid, zinc salt CCA, obtained from Orient Corporation of America, by emulsion polymerization demonstrates core/shell fabrication by process.

### Example 2

### Core Latex without Charge Control Additive

A core latex for particle formation was made by similar semi-continuous emulsion polymerization but in the absence of the 3,5 Di-tert-butylsalicylic acid, zinc salt charge control agent. A representative core latex emulsion preparation was as follows:

A monomer emulsion was prepared by agitating a monomer mixture of about 29 parts by weight of styrene, about 9.8 parts by weight of n-butyl acrylate, about 1.17 parts by weight of beta-carboxyethyl acrylate (Beta CEA) and about 0.20 parts by weight of 1-dodecanethiol with an aqueous solution of about 0.77 parts by weight of DOWFAX™ 2 A1 (an alkyldiphenyloxide disulfonate surfactant from Dow Chemical, and about 18.5 parts by weight of distilled water at about 500 revolutions per minute (rpm) at a temperature from about 20° C. to about 25° C.

About 0.06 parts by weight of DOWFAX™ 2 A1 and about 36 parts by weight of distilled water were charged in an 8 liter jacketed glass reactor fitted with a stainless steel 45° pitch semi-axial flow impeller at about 200 rpm, a thermal couple temperature probe, a water cooled condenser with nitrogen outlet, a nitrogen inlet, internal cooling capabilities, and a hot water circulating bath set at about 83° C., and de-aerated for about 30 minutes while the temperature was raised to about 75° C.

About 1.2 parts by weight of the monomer emulsion described above was then added into the reactor and was stirred for about 10 minutes at about 75° C. An initiator solution prepared from about 0.78 parts by weight of ammonium persulfate in about 2.7 parts by weight of distilled water were added to the reactor over about 20 minutes. Stirring continued for about an additional 20 minutes to allow seed particle formation. The remaining monomer emulsion was then fed into the reactor over about 190 minutes. After the addition, the latex was stirred at the same temperature for about 3 more hours to complete conversion of the monomer. Latex made by the process of semi-continuous emulsion polymerization resulted in useable latex particle sizes between 150 nm to 250 nm.

### Example 3

### Control Particle with No Core/Shell CCA Latex Additive

To a 2 liter jacketed glass reactor, about 358 parts by weight of the latex prepared in Example 2 above was combined with about 74 parts by weight of a Regal 330 pigment dispersion, about 17 parts by weight of a Sun PB 15:3 pigment dispersion (from Sun Chemicals Co.), about 68 parts by weight of a paraffin wax dispersion, and about 770 parts by weight of distilled water. The components were mixed by a homogenizer for about 5 minutes at about 4000 rpm. A separate mixture of about 4 parts by weight of poly(aluminum chloride) (from Asada Co.) in about 36 parts by weight of 0.02 M of HNO₃ solution was added drop-wise into the reactor. After the addition of the poly(aluminum chloride) mixture, the resulting viscous slurry was homogenized at about 20° C. for about 20 minutes at about 4000 rpm. The homogenizer was removed and replaced with a stainless steel 45° pitch semi-axial flow impeller and stirred continuously throughout the process at about 350 to 250 rpm, while raising the temperature of the contents of the reactor to about 59° C., and held at this temperature until the particle size was about 5.6 microns.

Shell addition. About 173 parts by weight of the latex prepared above in Example 2 was then added drop-wise. After the complete addition of the latex, the resulting slurry was stirred for about 30 minutes, at which time sufficient 1 molar NaOH was added into the slurry to adjust the pH to about 5.1. At this time the stirring was lowered to about 160 rpm for an additional 3 minutes after pH adjustment. At the end of the 3 minutes the bath temperature was adjusted to about 98° C. to heat the slurry to about 96° C. During the temperature increase to 96° C. the pH of the slurry was adjusted to about 4.3 by the addition of 0.3 M HNO₃ solution at about 90° C. The slurry was then coalesced for about 0.75 hours at a temperature of about 96° C. At this time the reactor contents were cooled to about 63° C., sufficient 1 molar NaOH added to the slurry to adjust the pH to about 7.2, held for 30 minutes at 63° C., and cooled to about 30° C. The toner particles thus obtained were collected by filtration. After washing and drying, the diameter of the resulting toner particles was about 6.1 microns.

### Comparative Example 4

### Particle Formation with Core/Shell CCA Latex

To a 2 liter jacketed glass reactor, about 358 parts by weight of the latex prepared in Example 2 above was combined with about 74 parts by weight of a Regal 330 pigment dispersion, about 17 parts by weight of a Sun PB 15:3 pigment dispersion (from Sun Chemicals Co.), about 68 parts by weight of a paraffin wax dispersion, and about 770 parts by weight of distilled water. The components were mixed by a homogenizer for about 5 minutes at about 4000 rpm. A separate mixture of about 4 parts by weight of poly(aluminum chloride) (from Asada Co.) in about 36 parts by weight of 0.02 M of HNO₃ solution was added drop-wise into the reactor. After the addition of the poly(aluminum chloride) mixture, the resulting viscous slurry was homogenized at about 20° C. for about 20 minutes at about 4000 rpm. The homogenizer was removed and replaced with a stainless steel 45° pitch semi-axial flow impeller and stirred continuously throughout the process at about 600 to 450 rpm, while raising the temperature of the contents of the reactor to about 61° C., and held at this temperature until the particle size was about 5.4 microns.

Shell addition. A shell latex, as in Examples 3, was modified by substituting about 20% of the core latex from Example 2, with the latex from Example 1. Thus, a mixture of about 138 parts by weight of the latex prepared above in Example 2 and about 37 parts by weight of latex prepared above in Example 1, with incorporated 3,5 Di-tert-butylsalicylic acid, zinc salt CCA, obtained from Orient Corporation of America, was added drop-wise to form a shell. After the complete addition of the latex, the resulting slurry was stirred for about 30 minutes, at which time sufficient 1 molar NaOH was added into the slurry to adjust the pH to about 4.6. At this time the stirring was lowered to about 160 rpm for an additional 3 minutes after pH adjustment. At the end of the 3 minutes the bath temperature was adjusted to about 98° C. to heat the slurry to about 96° C. During the temperature increase to 96° C. the pH of the slurry was adjusted to about 4.0 by the addition of 0.3 M HNO₃ solution at about 92° C. The slurry was then coalesced for about 0.75 hours at a temperature of about 96° C. At this time the reactor contents were cooled to about 63° C., sufficient 1 molar NaOH added to the slurry to adjust the pH to about 7.4, held for 30 minutes at 63° C., and cooled to about 30° C. The toner particles thus obtained were collected by filtration. After washing and drying, the diameter of the resulting toner particles was about 5.9 microns.

The particles of example 3 and comparative example 4 were then tested in a machine fixture that was modified to obtain the triboelectric charge (μC/g) of the toner directly from the donor roll. As can be seen, the particles of Example 2 had a tribo charge of about −36.7 μC/g. The toner of comparative Example 4, however, had a tribo charge of −58.8 μC/g. when incorporated with 20% core/shell CCA latex with 3,5 Di-tert-butylsalicylic acid, zinc salt.

Table I shows the results of the tribo charge of the comparative examples 3 and 4.

TABLE I

| | Tribo |
|---|---|
| Particle | (μC/g) |
| Example 3 | −36.7 |
| Example 4 | −58.8 |

The particle in comparative example 4 prepared with latex Example 1, with incorporated 3,5 Di-tert-butylsalicylic acid, zinc salt, when used in the toner particle shell as part of the shell latex, demonstrated the ability to provide a more negative charge to the toner particle. The process of the present disclosure provides an alternative way to incorporate a charge control agent by coating a latex particle with a shell containing a negative charge control agent, thus forming a latex with a core without CCA and a shell containing the CCA by emulsion polymerization technique. Further, the process enables the use of less CCA as compared to synthesizing a latex with CCA incorporated throughout the entire latex—70% less CCA used.

It will be appreciated that variations of the above-disclosed and other features and functions, or alternatives thereof, may be desirably combined into many other different systems or applications. Also that various, presently unforeseen or unanticipated, alternatives, modifications, variations or improvements therein may be subsequently made by those skilled in the art which are also intended to be encompassed by the following claims.

What is claimed is:

1. A toner particle comprising:
a core; and
a polymeric shell encapsulating the core and having at least one charge control agent intercalated within;
wherein the core is substantially free of the charge control agent.

2. The toner particle according to claim 1, wherein the charge control agent is a metal salicylic salt.

3. The toner particle according to claim 2, wherein the charge control agent is 3,5 Di-tert-butylsalicylic acid, zinc, or aluminum salt.

4. The toner particle according to claim 1, wherein the charge control agent is present in an amount of from about 0.01 to about 4.5 percent by weight of the shell.

5. The toner particle according to claim 4, wherein the polymeric charge control agent is present in an amount of up to about 36% by weight of the toner particle.

6. The toner particle according to claim 1, wherein the core includes:
a resin;
optionally a wax, and
one or more pigments.

7. The toner particle according to claim 1, wherein the core has a diameter from about 4.8 microns to about 6.9 microns.

8. The toner particle according to claim 1, wherein the core has a diameter of about 6.4 microns.

9. The toner particle according to claim 1, wherein the shell has a thickness from about 0.1 microns to about 1.0 microns.

10. The toner particle according to claim 1, wherein the shell has a thickness of about 0.6 microns.

11. The toner particle according to claim 13, wherein toner particle has a tribo charge of −58.8 μC/g.

12. A toner composition comprising:
a toner particle having:
a core including at least a resin, optionally a wax, and one or more pigments, the core being substantially free of a charge control agent;
a polymeric shell encapsulating the core and having at least one charge control agent intercalated within; and
one or more flow aid additives.

13. The toner composition according to claim 12, wherein the flow aid additive or additives is selected from the group consisting of titanium oxide, silicon oxide, tin oxide, colloidal and amorphous silicas, metal salts, zinc stearate, aluminum oxides, cerium oxides, and mixtures thereof.

14. The toner composition according to claim 12, wherein the charge control agent is 3,5 Di-tert-butylsalicylic acid, zinc, or aluminum salt.

15. The toner composition according to claim 12, wherein the charge control agent is present in an amount of from about 0.01 percent to about 4.5-percent by weight of the shell.

16. The toner composition according to claim 4, wherein the polymeric charge control agent is present in an amount of up to about 36% by weight of the toner particle.

17. A method for making a toner particle comprising the steps of:
forming a particle core;
encapsulating the particle core with a shell comprising a charge control agent;
keeping the particle core substantially free of the charge control agent.

18. The method according to claim 17, wherein the core particle is formed by:
dispersing at least one resin with one or more pigments, a surfactant, and a wax to form particles; and
aggregating the particles to form the particle core.

19. The method according to claim 17, wherein the charge control agent is 3,5 Di-tert-butylsalicylic acid, zinc or aluminum salt.
